(19) United States
(12) Patent Application Publication
(10) Pub. No.: US 2024/0292227 A1
(43) Pub. Date: Aug. 29, 2024

(54) SYSTEMS AND METHODS FOR ARCHIVAL OF DATA CAPTURES FROM A MOBILE COMMUNICATION NETWORK

(71) Applicant: MATIC HOLDINGS, LLC., Warner, NH (US)

(72) Inventor: Kenneth Michael Thompson, Warner, NH (US)

(21) Appl. No.: 18/571,476

(22) PCT Filed: Jun. 21, 2022
(86) PCT No.: PCT/US2022/034307

§ 371 Date: Dec. 18, 2023

Related U.S. Application Data
(60) Provisional application No. 63/213,141, filed on Jun. 21, 2021.

(51) Int. Cl. H04W 12/80

(52) U.S. Cl. CPC H04W 12/80

(57) ABSTRACT

One aspect of the present disclosure is a system for arbitration of data captures from a mobile communications network. The system comprising a memory with a plurality of capture rules stored therein, each capture rule of the plurality of capture rules defining a criterion and being associated with a target destination, an archival plane controller (APC) to receive a first data capture from the mobile communications network, identify at least one capture rule of the plurality of capture rules stored in the memory that is associated with the first data capture, and send an indication of the first data capture to the target destination associated with the at least one identified capture rule.

### TECHNICAL FIELD

This specification relates to communication systems, and more particularly, to systems and methods for archival of data captures from a mobile communication network.

### BACKGROUND INFORMATION

First responders and governmental agencies are increasingly adopting mobile communications as a primary mode of communicating both intra and inter-agency. Archival logging of communications propagated via mobile communications networks raises numerous non-trivial challenges.

### BRIEF DESCRIPTION OF THE DRAWINGS

These and other features will be better understood by reading the following detailed description, taken together with the drawings wherein:

FIG. 1 is an example of a mobile communication network consistent with aspects of the present disclosure.

FIG. 2 shows an example of an archival plane controller (APC) configured to receive data captures from the mobile communication network of FIG. 1 in accordance with aspects of the present disclosure.

FIG. 3 shows an example configuration of the APC of FIG. 2 in accordance with aspects of the present disclosure.

FIG. 4 shows an example method for execution by the APC controller of FIG. 2, in accordance with aspects of the present disclosure.

FIG. 5 shows another example method for execution by the APC controller of FIG. 3, in accordance with aspects of the present disclosure.

The drawings included herewith are for illustrating various examples of articles, methods, and apparatuses of the teaching of the present specification and are not intended to limit the scope of what is taught in any way.

### DETAILED DESCRIPTION

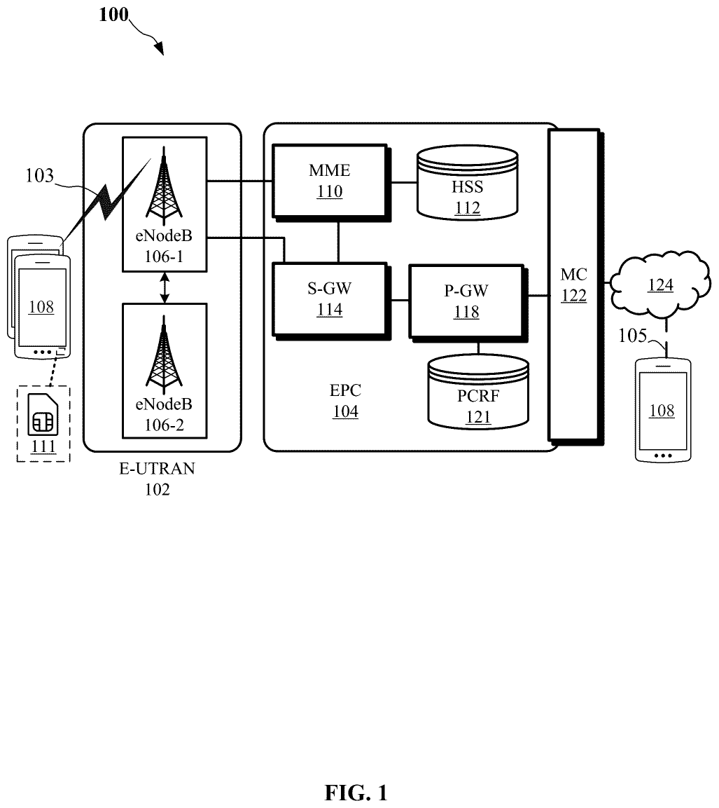

FIG. 1 shows an example mobile communication network 100 consistent with aspects of the present disclosure. The mobile communication network 100 preferably implements a Long Term Evolution (LTE) network which can provide voice and/or data services to N number of subscriber users. For example, the mobile communication network 100 can implement a packet-switched architecture such as defined by the 3rd Generation Partnership Project (3GPP).

More preferably, the mobile communication network 100 implements a nation-wide, broadband mission critical (MC) communication (MCC) network. The MCC network preferably operates on spectrum allocated by the Federal Communications Commission (FCC) as D-Block spectrum (758-763 MHz/788-793 MHZ), with D-Block spectrum being dedicated to public safety and governmental use in Mission Critical Networks. Some such Mission Critical Networks are authorized to use both the existing public safety broadband spectrum (763-769 MHz/793-799 MHZ) and the allocated D-Block. Within the D-Block spectrum, Mission Critical Networks tend to favor a relatively narrow band of spectrum such as Band 14 spectrum, which represents 20 MHz of spectrum in the 700 MHz band. Band 14 spectrum is particularly well suited for signal propagation in urban and rural areas, as well as for penetration into buildings. Accordingly, the mobile communication network 100 preferably utilizes the 700 MHz band for communication, and more preferably, the Band 14 spectrum of the 700 MHZ band. However, other spectrum bands are within the scope of this disclosure.

The mobile communication network 100 preferably includes a plurality of user devices 108, an evolved Universal Mobile Telecommunications System Terrestrial Radio Access Network (E-UTRAN) 102, and an evolved packet core (EPC) 104 (which may also be referred to as an enhanced packet core). User devices can also utilize a wide area network (WAN) such as the Internet to couple to the mobile communication network 100, and in particular, to attach/couple to the mobile communication network 100 via a secondary network 105, and thus, without the necessity of attachment through the E-UTRAN 102. As such, the plurality of user devices 108 can comprise any device capable of communicating/attaching with the mobile communication network 100 such as through wireless signaling, e.g., radio frequency (RF) signals 103 that comport with 3GPP standards, and 802.11x signaling also known as Wi-Fi, or through wired connections. Preferably, the RF signals 103 to/from the plurality of user devices 108 have a frequency in the 700 MHz range, and more preferably, in the Band 14 spectrum. Some such example devices include smart phones, cellular push-to-talk (PTT) radio devices, laptop computers, Internet-of-Things (IoT) devices, camera sensors including dash-cams and body cameras, autonomous land-based vehicles and arial drones, and robotic bomb disposal units. The plurality of user devices 108 may also be referred to herein as user equipment (UE).

In any such cases, the plurality of user devices 108 are preferably configured to utilize universal integrated circuit cards (UICCs) 111, which are also commonly referred to as SIM cards in the context of LTE networks. The UICC 111 can execute an application known as a Universal Subscriber Identity Module (USIM). The USIM includes a memory (not shown) that stores subscriber-related information and can also include security-related information such as particular cryptographic data, e.g., a cryptographic key (Ki), to utilize for securing communications with the mobile communications network. The subscriber-related information can include, for example, the phone number for the subscriber, and a home network identity. The subscriber-related information can further include one or more profiles. These profiles may be utilized to modify operation of the particular UE in which the SIM is inserted/coupled, and/or operation of the mobile communication network 100. The profiles may also be utilized to initiate/enable data captures for a given UE, as discussed in greater detail below.

Consider one example where a subscriber utilizes two different devices to access/attach to the mobile communication network 100 such as a first device implemented as a smart phone and a second device implemented as a laptop computer. The USIM can include a first profile associated with the first device and a second profile associated with the second device. Based on the USIM being inserted into the first device, i.e., the smartphone, the first profile may then be activated and cause the smart phone to adjust at least one operation. The term activated in the context of a profile of a USIM refers to a UE electrically coupling to the USIM and selecting the profile for local operation, e.g., to provide provisioning data such as a phone number, encryption keys, and/or enabled feature flags. Some such example local operations of the UE based on an activated profile can therefore include utilizing the subscriber-specific data to provide initial provisioning such as the subscriber's telephone number, enabled hardware and/or software features, and encryption key(s) for accessing secure areas such as secure memory areas and secure hardware components (e.g., hardware-based key store and signature generators).

Alternatively, or in addition, insertion of the UICC 111 into the first device and activation of the first profile can cause a change to at least one operational characteristic of the mobile communication network 100 when the first device couples/attaches to the same. The at least one operational characteristic changed by the mobile communication network 100 in this scenario can include a change that is specific/limited to the specific UE, such as setting a maximum data rate for communication to/from a UE. Alternatively, or in addition, the operational characteristic changed by the mobile communication network 100 can adjust a so-called “global” operational characteristic for the same. On such example in the context of the mobile communication network 100 implementing a MCC network includes prioritizing access and/or bandwidth, e.g., system-wide, based on the first profile having an elevated/high ‘priority’ value, which may also be referred to herein as a high priority subscriber profile or simply a high priority subscriber. By way of contrast, regular or non-high priority subscribers can include a profile without a priority designator/value, or a with a priority value that is less than a high-priority subscriber. Such priority values can manifest as a priority flag, e.g., a logical true/false, or as a priority value within a range. The mobile communication network 100 may then utilize the first activated profile to prioritize access and/or dedicate a predefined portion of bandwidth for the UE.

Continuing the prior example of the mobile communication network 100 operating as a MCC network, the mobile communication network 100 thus preferably guarantees that those high-priority subscribers can attach/couple to the mobile communication network 100 (regardless of current load), that the request to attach by the high-priority subscribers is processed in a priority manner relative to lower-priority subscribers, and that a minimum bandwidth within the mobile communication network 100 is guaranteed/dedicated for use by the high-priority subscriber. This may result in, for example, the mobile communication network 100 limiting the maximum number of UEs attached/coupled to the mobile communication network, dropping connection to one or more lower-priority UEs, limiting the maximum data rate/bandwidth to the lower-priority UEs, or any combination thereof.

The E-UTRAN 102 preferably includes a plurality of tower-based nodes which are referred to as eNodeBs. Each eNodeB can include hardware that allows for the plurality of user devices 108 to attach to the mobile communication network 100, and for converting RF signals 103 from the plurality of user devices 108 into digital form, e.g., packets, for propagation via the EPC 104. Likewise, each eNodeB can include hardware that can convert packet data from the EPC 104 into RF signals 103 which are sent to the plurality of user devices 108. As shown, the E-UTRAN 102 preferably includes at least a first eNodeB 106-1 and a second eNodeB 106-2. Each of the eNodeBs may be disposed at different geographic locations to provide a corresponding coverage area. The coverage areas provided by each eNodeB can overlap with each other. The eNodeBs can couple to the EPC 104 via a network connection. The E-UTRAN 102 can also include a radio network controller (RNC) (not shown) to control each of the eNodeBs.

As shown in the example of FIG. 1, the EPC 104 comprises a mobility management entity (MME) 110, a home subscriber server (HSS) 112, a serving gateway (S-GW) 114, a packet data network gateway (PDN-GW) 120, and a policy and charging rules function (PCRF) module 121. The EPC 104 further preferably includes a MC controller 122, which is discussed in further detail below. The EPC 104 can further couple to one or more packet data networks 124, such as the Internet.

The MME 110 handles the signaling related to the mobility and security for E-UTRAN access by the plurality of user devices 108. The MME 110 handles operations such as the tracking and paging of UEs in idle-mode.

The HSS 112 includes a database that contains user-related and subscriber-related information. The HSS 112 can also be utilized by the MME 110 for purposes of supporting mobility management including attachment, call and session setup, user authentication and access authorization.

The S-GW 114 and P-GW 118 provide control transport of IP data traffic/packets between UEs, and also between the mobile communication network 100 and external networks such as the one or more PDNs 124. Each eNodeB of the E-UTRAN 102 can couple to the MME 110 and the S-GW 114, such as shown in FIG. 1. The eNodeBs may then utilize the MME 110 and the S-GW 114 for the purposes of routing packet data to/from UEs.

The PCRF 121 manages subscriber policy enforcement and flow-based charging for use of the mobile communications network 100.

The MC controller 122 is configured to ensure that the EPC 104 can provide MC functionality, such as UE prioritization and bandwidth allocation, as discussed above. In addition, the MC controller 122 can further provide a signal control plane (or communication control plane) that can support multi-media services such as flow control for MC PTT and media streaming including audio and/or video. The communication control plane provided by the MC controller 122 can further enable generation of data captures as discussed further below.

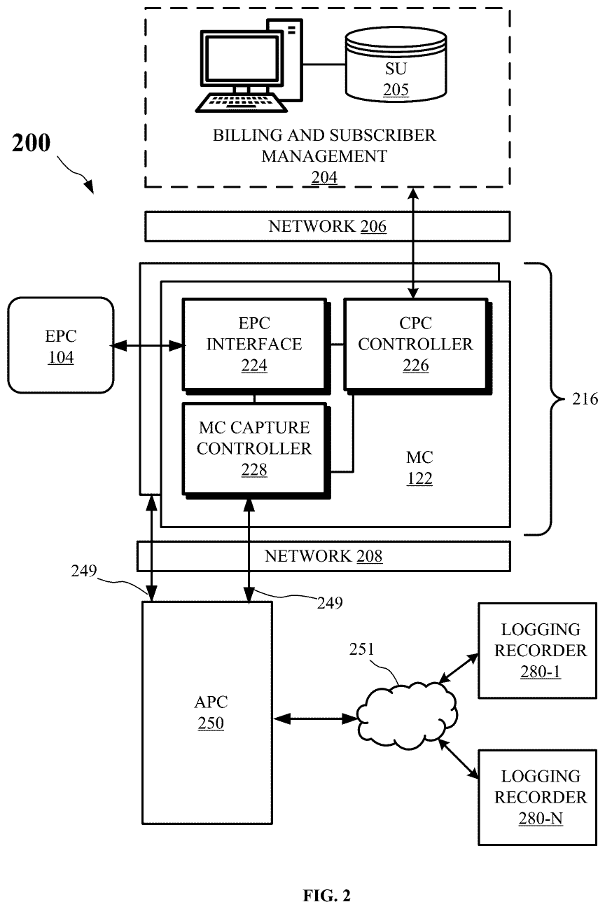

FIG. 2 shows an example 200 of the MC controller 122 communicating with an archival plane controller (APC) 250 consistent with aspects of the present disclosure. As shown, the example 200 includes the MC controller 122 coupled to a billing and subscriber management server 204 via a first network 206. The billing and subscriber management server 204 is preferably owned and operated by the carrier responsible for the deployment and maintenance of the mobile communication network 100. The billing and subscriber management server 204 preferably includes a subscriber unit (SU) database 205. The SU database 205 preferably includes a database that defines subscription information for each subscriber user. More preferably, the SU database 205 includes a database that associates each subscriber user with a respective subscriber agency. For example, and in the context of MCC, a subscriber agency could be a particular police department for a town or city and the SU database 205 can include a mapping table that associates each subscriber unit within their respective subscriber agency, e.g., each officer, dispatcher, or other employee, with their agency identifier.

The SU database 205 can also preferably include an archival flag associated with each agency and/or with each user. The archival flag can indicate if communications to/from a given subscriber user, or from all subscriber users within an agency, should be captured for archival. These captures are referred to herein as archival data captures or simply data captures. A data capture refers to storing of any information (e.g., bytes) that is sent to/from a given subscriber user via a data packet propagated through the EPC 104. Such data captures can include the entirety of a communication (e.g., from key up to teardown) or only a portion of the communication. Such data captures can include audio samples, one or more image frames, audio samples and image frames (e.g., multi-media), text data, and/or any other data payload propagated through the EPC 104. In one example, the data captures can include audio and/or video samples that comport with a codecs standardized by 3GPP and/or ITU-T. Some such example codecs can include AMR, AMR-WB, AMR-WB+, G.711, G.711.1, G.718, G.718B, G.719, G.722, G.722.1, G.722.1C. In another example, the codec of data captures may comport with other standards such as the Project 25 (P25) digital radio standard.

In any such cases, the data captures can further include any related messaging including all packets that were used to propagate a communication through the communication system 100. This capture may be analogous to a ‘Wireshark’ capture which seeks to maintain a forensic/unaltered representation of the packet data for analysis purposes. The data captures can also include meta data associated with communications that is not necessarily delivered in-line with communication data payloads such as subscriber-identifying information, geographic location information, and prioritization information. Still further additional capture data type and meta data examples include data that comports with NENA's Functional and Interface Standards for Next Generation 9-1-1, commonly referred to as i3. This ‘i3’ data can be received (directly) from an i3 data source (not shown) by the MC controller 122 and/or via data packets propagated over the communication system 100.

The MC controller 122 comprises a plurality of components for supporting mission critical functions. For example, and as shown, the MC controller 122 includes an EPC interface 224, a communication plane controller (CPC) 226, and a MC capture controller 228. The plurality of components can be implemented in hardware, software, or a plurality of hardware and software. Preferably, the components of the MC controller 122 are implemented via one or a plurality of server computers. The server computers can include various components such as random access memory (RAM) and a controller/processor, which are not shown for brevity. Each server computer preferably includes at least one controller configured to execute the various processes and features attributed to the MC controller 122 as disclosed herein. Note, in some scenarios a plurality of MC controllers 216 may be implemented for fault tolerance and/or load balancing.

The EPC interface 224 can include hardware, software, or a combination of hardware and software for communicating with components of the EPC 104. The EPC interface 224 can include, for example, a network interface circuit (not shown) to communicate with the EPC 104 via IP packet data, for example.

The CPC controller 226 preferably utilizes the subscriber information within the billing and subscriber management server 204 to provide MC functionality. The CPC controller 226 can utilize the EPC interface 224 to control the data transport plane of the EPC 104, and more specifically, the data transport plane provided by the S-GW 114 and the P-GW 118 (See FIG. 1). The CPC controller 226 may then cause the EPC 104 to prioritize packet data based on the prioritization defined within the SU database 205, for example.

The MC capture controller 228 can be configured to generate data captures for communications propagating through the EPC 104. The MC capture controller 228 preferably outputs the generated data captures via signaling 249 to the APC 250. The signaling 249 is preferably implemented as ethernet/IP packets sent via a second network 208. The second network 208 preferably isolates the MC controller 122 and/or the EPC 104 from the APC 250. However, it should be noted that the APC 250 may be implemented whole, or in part, within the MC controller 122 and not necessarily be implemented as a separate component.

The CPC controller 226 can cause the MC capture controller 228 to generate data captures for all communications propagating through the EPC 104, or selectively generate data captures for communications associated with one or more subscribers and/or agencies having the archival flag set to true in the SU database 205, for example. Each data capture can include a copy of the bytes that represent the plurality of packets for a given communication, and can also include associated signaling and routing information for the packet such as the identifier for a particular eNodeB, S-GW and/or P-GW through which packet flow occurred. In addition, each data capture can include meta data information such as an identifier of the subscriber user initiating a communication, the subscriber user(s) receiving the communication, geographical identifiers (global positioning satellite coordinates) for the initiating subscriber and/or receiving subscriber(s), and/or subscriber agency identifiers for various subscribers associated with the communication.

Preferably, each data capture generated by the MC capture controller 228 includes a data payload that includes a representation of at least a portion of a communication that propagated through the one or more nodes providing the EPC 104. The MC capture controller 228 can generate a single data capture for each communication, or a plurality of data captures. For example, the MC capture controller 228 can utilize a predetermined maximum payload parameter, such as 512 bytes, 1024 bytes, or other suitable value. The MC capture controller 228 may then “break up” communications when their associated size exceeds the predetermined maximum payload parameter. For instance, a communication totaling 5 MB (or 5242880 Bytes) may be divided into five different frames/segments/sections/chunks based on the predetermined maximum payload parameter and used to generate five corresponding data captures. These frames are preferably assigned an index that corresponds to their relative position, e.g., the beginning frame of a communication has a first index (e.g., 0) and the frames that follow are consecutively numbered (e.g., from 1 to 4).

Preferably, the MC capture controller 228 outputs these data captures via signaling 249 in a sequence that corresponds with the assigned index for each frame, e.g., the frame with the lowest index is output first.

The MC capture controller 228 can also encrypt generated data captures, or at least portions thereof such as the data payload. The encryption may be based on the subscriber users and/or subscriber agencies associated with the data capture, and may utilize agency encryption data stored within the SU database 205 or other suitable key store, for example. The encryption may also be based on temporary encryption keys generated by the MC capture controller 228 (or other suitable node in the mobile communication network 100), with the temporary encryption keys being synced with the local key store 386 of the APC 250. As discussed further below, the APC 250 preferably encrypts, or re-encrypts as the case may be, the generated data captures using encryption keys/data for the various subscriber agencies and/or subscriber users associated with the data capture. Thus, a subscriber agency can receive their associated data captures in a secure form that can be decrypted using their specific encryption keys/data.

In one preferred example, the APC 250 is a cloud-based server instance deployed in Azure by Microsoft, Inc. or in Amazon Web Services (AWS) offered by Amazon Web Services, Inc. Alternatively, or in addition to cloud based servers, the APC 250 may also be implemented in an on-premises server computer.

The APC 250 is preferably configured to receive data captures output by the MC capture controller 228 via signaling 249. The APC 250 is then preferably configured to propagate/send a capture notification message to one or more target destinations associated with the received data captures output by the MC controller 228. The target destinations preferably correspond with network address/identifiers of logging recorders, although other destinations are within the scope of this disclosure such as network attached storage (NAS) devices and blob storage instances.

The APC 250 preferably sends the capture notification message via a third network, such as a Wide Area Network 251 (e.g., the Internet). The target destination for each capture notification message can be one or more logging recorders, such as logging recorders 280-1 and 280-N. The logging recorders 280-1 and 280-N are preferably configured as computer-based logging recorders capable of storage voice, video and data communications for long term purposes.

Each capture notification message can include an indication of a data capture, e.g., such as a capture identifier for a data capture (e.g., a GUID), and/or payload data for the data capture. The payload data for the data capture can be the entirety of the payload data for a communication, or a portion of the payload data. For instance, each capture notification message can include a predetermined maximum number of bytes for the payload, such as 512 or 1024 bytes as discussed above. In scenarios where the capture notification message includes the capture identifier for the data capture, a remote server can send a request to the APC 250 for the data capture using the capture identifier. The APC 250 may then send the data capture, including the data payload, to the remote server in response. Thus, the APC 250 may not necessarily send the data payload for data captures until a specific request for the data capture is received (e.g., to provide store-and-forward capability).

The APC 250 may send a capture notification message for each data capture received from the MC capture controller 228 (e.g., in a 1:1 fashion), and/or send a capture notification message for a plurality of data captures received from the MC capture controller 228.

For example, as discussed above, the MC capture controller 228 may generate and output a plurality of data captures associated with the same communication, which for clarity will be referred to in the preceding description as a first communication. In this example, APC 250 may receive the plurality of data captures output by the MC capture controller 228 corresponding to the first communication. The APC 250 may then compare the total number of received data captures for the first communication to a predetermined threshold. The APC 250 may then send a capture notification message based on the total number of received data captures for the first communication exceeding the predetermined threshold. The APC 250 may also send a capture notification message after determining that all data captures for the first communication have been received. This determination may be based on a capture end flag within the data captures output by the MC capture controller 228 and/or via a separate message to indicate end of capture. It should be noted that the MC capture controller 228 may also include a start of capture indicator, such as a flag within the first data capture for a given communication and/or through a separate message to indicate start of capture.

The APC 250 may be configured to send an acknowledgement (ACK) message to the MC capture controller 228, via the second network 208, for each data capture received from the MC capture controller 228. The ACK message sent by the APC 250 to the MC capture controller 228 can be configured to cause the MC capture controller 228 to send a next data capture for a given communication. Subsequent to sending the ACK message to the MC capture controller 228, the APC 250 may receive a next data capture in the sequence, when available, or an end of capture message as discussed above.

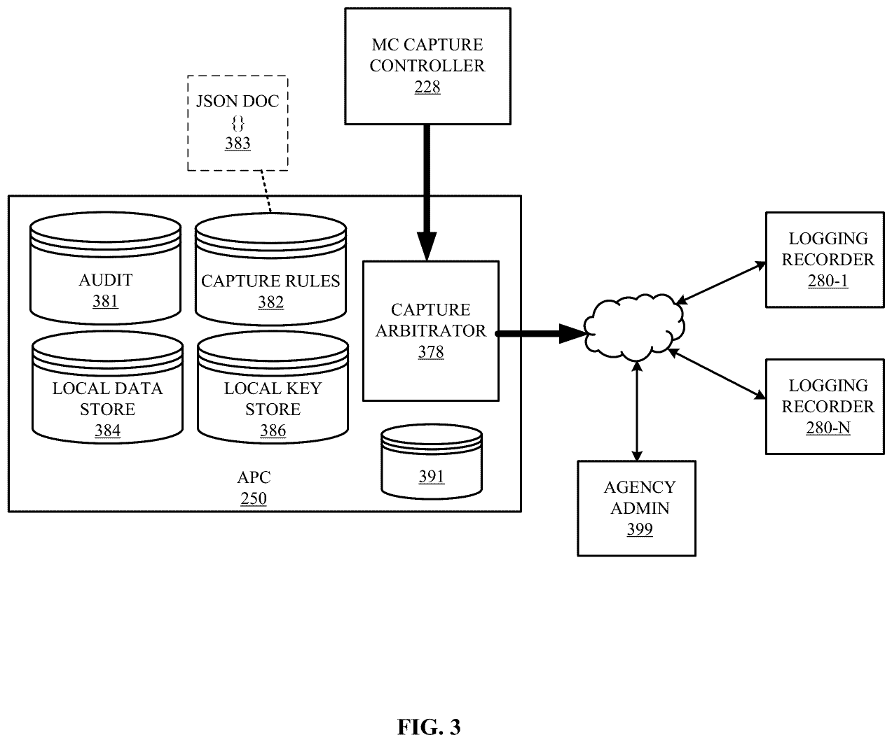

FIG. 3 shows an example of the APC 250 in accordance with aspects of the present disclosure. As shown, the APC 250 includes a plurality of components that may be implemented via a single server, or a plurality of servers. Preferably, and as discussed above, the plurality of components of the APC 250 are implemented in a cloud-based platform such as Azure. The components of the APC 250 preferably include a capture arbitrator 378, an audit database 381, a capture rule database 382, and a local key store 386.

The capture arbitrator 378 may also be referred to herein as a capture arbitration controller. The capture arbitrator 378 is preferably configured to receive data captures output by the MC capture controller 228.

The capture arbitrator 378 is further preferably configured to instantiate one or more capture rules in a memory, such as the local data store 384. The capture arbitrator 378 can compare each received data capture to the instantiated capture rules. The capture arbitrator 378 may then identify at least one capture rule that is associated with the received data captures. In scenarios where a plurality of data captures are received for a single communication, as discussed above, this rule analysis may be performed only on the first data capture, with the remainder of the received data captures not being compared to the rules by the capture arbitrator 378. However, the capture arbitrator 378 preferably compares each data capture to the instantiated capture rules as the properties/characteristics of communications can change dynamically based on events such as a subscriber user being added/conferenced into a communication. Accordingly, one or more initial rules identified as applicable by the capture arbitrator 378 at a beginning of a data capture sequence may become inapplicable later during the communication, e.g., when a conferenced subscriber user drops from the communication. Likewise, as characteristics/parameters for a communication changes, additional capture rules may be identified as applicable to the data capture sequence.

The capture rules database 382 comprises flat file, relational database, or other suitable data store. The capture rules database 382 preferably comprises a plurality of capture rules. Each of the plurality of capture rules may be associated with one or more subscriber agencies. Alternatively, or in addition, each of the plurality of capture rules may be associated with one or more specific subscribers. Thus, the capture rules preferably provide fine-grain control of capture conditions that can be applied at an agency level, an individual subscriber level, or a combination of both.

Each capture rule within the capture rules database 382 is preferably implemented in a format such as JavaScript Object Notation (JSON). Each capture rule preferably includes an identifier of a capture criterion and a target value or range of target values for the capture criterion. One such JSON capture rule 383 is shown in the example of FIG. 3. The capture criterion may also be referred to as capture criterion sets or simply criterion sets. More preferably, each capture rule includes a plurality of such capture criteria and target values/value ranges, which may also be referred to herein as capture conditionals or simply conditionals. The conditionals may then be nested and associated using logical operators such as AND/OR/XOR. Thus, conditionals may be as simple as single capture criterion, or a plurality of logical conditions that can be used for fine-grain selection of capture criteria and subsequent actions to perform such as optional conversion between format types for the data payloads from the data captures (e.g., transcoding of audio and/or video from a first codec to a second codec), encryption of data captures using keys/authentication data specific to one or more target destinations, and/or the sending of applicable data captures to one or more primary target destinations and optional failover transfers to secondary target destinations.

The capture criterion can be any characteristic/parameter that the MC capture controller 228 provides via a payload and/or within meta data for each data capture. Some such example parameters can include a subscriber user identifier for any user subscriber associated with the communication, e.g., an International Mobile Equipment Identity (IMEI) for the UE, a unique username for the subscriber (e.g., an email address or login name), subscriber agency identifier(s) associated with the communication, priority value(s) for the subscriber user(s) associated with the communication, the endpoint for the communication (e.g., the phone number), the type of communication that was captured (e.g., text, voice, video/multi-media), the geographic location(s) of the subscriber user(s) associated with the communication, and/or the device type identifier(s) for the subscriber user(s) associated with the communication.

Alternatively, or in addition, the parameters can also further include an identifier for one or more components of the mobile communication network 100 propagating the communication including node identifier(s) of the E-UTRAN(s), the cNodeB(s), the MME(s), S-GW(s), P-GW(s), and/or MC controller(s).

Alternatively, or in addition, the parameters can also further include quality of service indicators including power levels (in decibels) for each UE associated with a communication, bit error rates, and noise level.

Alternatively, or in addition, the parameters can also further include an identifier of the particular communication protocol (e.g., a signaling standard such as 3GPP 3G/4G/5G, VoIP/SIP) for the subscriber user(s) of a communication.

Alternatively, or in addition, the parameters can also further include data from UICC of the subscriber(s) associated with the call. Such data can include, for example, an identifier of an active profile, priority information, and encryption information such as the session key for the UE generated during an attachment procedure with the EPC 104.

Each capture rule of the plurality of capture rules within the capture rules database 382 further preferably include an identifier of at least one target destination for data captures received from the MC capture controller 228. The at least one target destination can be a uniform resource identifier (URI) such as an IP address or uniform resource locator (URL). Each capture rule of the plurality of capture rules within the capture rules database 382 may further include a destination priority indicator associated with each target destination. The priority indicator can be, for example, an integer value between 0 and 5, with the lower numbers indicating target destinations with a highest priority, or vice-versa. Two or more target destinations can include a same priority value for purposes of mirroring. In some instances, the higher or otherwise lower-priority target destinations may be utilized as a backup destination in the event communication with the higher-priority destination(s) fail.

Each capture rule of the plurality of capture rules within the capture rules database 382 can further optionally include an identifier of a target format type. The target format type may be utilized to set a desired media format for data captures sent to the target destination(s). The target format type can include, for instance, a media codec, compression level, and/or frame rate. The capture arbitrator 378 may then utilize the target format type for purposes of converting/transcoding the data captures from an original format, e.g., from a 3GPP format, to a secondary format. The conversion can occur locally within the capture arbitrator 378, e.g., on the same server or cloud instance, or can occur remotely via requests by the capture arbitrator 378 or other component within the APC 250 to an external server (not shown). Each target destination within a given rule may be associated with the same or different identifier for the target format type. Note, conversion of data captures between formats is optional, and in one preferred example data captures are sent to target destinations with data payloads in the format as originally output by the MC capture controller 228 (e.g., in the original format used to propagate packets through the communication system 100).

The audit database 381 comprises flat file, relational database, or other suitable data store. The audit database 381 is preferably implemented via a plurality of database instances via mirroring or other suitable replication approach. The audit database 381 preferably includes a capture log table that includes at least one entry for each data capture received from the MC capture controller 228. Each entry can include, for example, an identifier for each data capture received from the MC capture controller 228 and at least one property associated with the data capture. The identifier for each data capture is preferably a unique identifier (such as a GUID) that uniquely identifies the data capture across the entire mobile communication network 100.

The at least one property can be any one, or a combination, of the data capture characteristics/parameters described above. Alternatively, or in addition, the at least one property is a disposition indicator for each data capture. The disposition indicator can include a value that indicates if a data capture has been successfully sent to one or more target destinations. Alternatively, or in addition, the disposition indicator can include identifier(s) of the target destination to which a data capture was sent. The disposition indicator may also further include an identifier of a network (e.g., the EPC 104, the Internet, or any other PDN identified within the mobile communication network 100) used to send the data capture to a target destination. The at least one property may further include a triggering rule value. The triggering rule value can include identifier(s) of capture rule(s) that caused a data capture to be sent to a given target destination.

The local data store 384 can be used by the capture arbitrator 378 for local storage purposes. The local data store 384 can comprise volatile memory (e.g., RAM) non-volatile memory, or a combination of both. The local data store 384 may also be utilized as the memory for instantiation of the capture rules by the capture arbitrator 378 as discussed above. The capture arbitrator 378 preferably uses the local data store 384 to store data captures received from the MC capture controller 228.

The local key store 386 is preferably implemented in a secure hardware device such as a trusted platform module (TPM). The local key store 386 can include one or more encryption keys. The one or more encryption keys may be provided to the local key store 386 based on requests to an external key store. Each encryption key of the one or more encryption keys within the local key store 386 can be associated with a subscriber agency, a subscriber user, or a plurality of subscriber users that may not necessarily belong to a same subscriber agency. Alternatively, or in addition, the local key store 386 can store certificates (e.g., X.509 certificates) for purposes of encryption and/or validation.

In operation, the capture arbitrator 378 receives a first data capture from the MC capture controller 228. The capture arbitrator 378 then preferably stores the first data capture in the local data store 384. More preferably, the first data capture is encrypted when stored in the local data store 384. This encryption preferably occurs transparently (e.g., without knowledge of the capture arbitrator 378 which is preferably executed in user space) when the data capture is transferred from kernel space of a network interface circuit (not shown) of the APC 250 to user memory, e.g., the local data store 384, which is accessible during runtime of the capture arbitrator 378. In this example, encryption can include a key exchange/certificate validation between a TPM (not shown) within the APC 250 and a remote certificate authority (CA) or other remote key store.

In some scenarios, this transparent key exchange/provisioning occurs with a component within the EPC 104 such as the MC capture controller 228. In this scenario, the TPM with the APC 250 can synchronize with the MC capture controller 228, or other suitable module of the mobile communication network 100, to ensure that the local key store 386 is provisioned with valid encryption data (e.g., encryption data that is synched with the encryption data used for generating data captures by the MC capture controller 228). This encryption data can include, but is not limited to, encryption keys, secret values and/or certificates (such as X.509 certificates).

The capture arbitrator 378 may then identify at least one capture rule stored in the plurality of capture rules database 382 that is associated with the first data capture. The identification can include, for each capture rule, comparing the capture criterion or criteria to the corresponding characteristic of the data capture. For example, if a first capture rule stored within the capture rules database 382 includes a capture criterion in the form a subscriber identifier and has a target value of 1 to satisfy the capture criterion, then the rule is considered applicable/satisfied if the first data capture includes the subscriber identifier with a value of 1. Note, this particular example is highly simplified for purposes of clarity. Capture rules within the capture rules database 382 can each include a plurality of conditionals, as discussed above, and predetermined actions for purposes of, for example, optionally transcoding/converting of data captures from a first format to a second format, encryption of data captures, and/or identification of target destinations and selection of those target destinations based on optional prioritization.

Consider one example scenario where a first data capture is received by the capture arbitrator 378 from the MC capture controller 228. The first data capture can include a plurality of capture characteristics including an originating subscriber user identifier, a receiving subscriber user identifier, a first subscriber agency identifier for the originating subscriber user identifier, and a second subscriber agency identifier for the receiving subscriber user identifier. In this scenario, a first capture rule can be stored in the capture rules database 382 and have a capture criterion set to the identifier of the originating subscriber user. This first capture rule can further include at least one target destination set to a first uniform resource identifier (URI) and an encryption key identifier set to a first value. Likewise, the second capture rule can be stored in the capture rules database 382 and have a capture criterion set to the identifier of the receiving subscriber user. The second capture rule can further include at least one target destination set to a second URI and an encryption key identifier set to a second value. In this scenario, the first and second users include different subscriber user identifiers and are associated with different subscriber agencies. Thus, the encryption identifier for each is preferably a different value. Preferably, the first encryption key identifier corresponds with a first key within the local key store 386, and the second encryption key identifier corresponds with a second key within the local key store 386. The first and second keys within the local key store 386 can correspond to the respective agencies of the users, or may corresponds specifically to the users themselves rather than be a global/agency key.

The capture arbitrator 378 may then receive a first data capture that has the qualifying criteria for the first rule, which is to say an originating subscriber user identifier matching the capture criterion in the above-mentioned first capture rule. The capture arbitrator 378 may then identify the first capture rule as applicable/satisfied. The capture arbitrator 378 does not identify the second rule as applicable given the associated criterion was not met by the first data capture. The capture arbitrator 378 then uses the first encryption key identifier within the first rule to query the local key store 386. The capture arbitrator 378 may then cause encryption of the first data capture to occur, and more specifically, encryption of at least the data payload of the first data capture. Preferably, this encryption is done in hardware without the first encryption key associated with the first key identifier being instantiated in user-space memory. Note, the encryption key used for encrypting the data capture may correspond to the session key associated with the originating subscriber user for the data capture.

The capture arbitrator 378 may then cause a capture indication message to be sent to a target destination based on the first URI discussed above. The capture indication message can include, for example, an identifier of the first data capture. This first URI can correspond with a logging recorder, such as the logging recorder 280-1. The capture indication message is preferably sent by a wide area network (e.g, the Internet) to the first URI as a push notification. Note, the capture indication message can also include the entire data payload for the first data capture or a portion thereof. The server at the first URI, e.g., the logging recorder 280-1, may then send a request message to the capture arbitrator 378. The request message can include the identifier of the first data capture. The capture arbitrator 378 can receive the request message. The capture arbitrator 378 can then send a message including at least a portion of the first data capture, such as the data payload or a portion thereof, based on the received request message. In some cases, the capture arbitrator 378 sends a plurality of response messages, with the plurality of response messages collectively sending the entirety of the data payload of the first data capture received from the MC capture controller 228, or more preferably the entirety of the data pay load and the meta data associated with the first data capture.

Likewise, data captures (e.g., a second data capture) received from the MC capture controller 228 and associated with only the second capture rule can be encrypted and sent based on the second key identified, using a sequence similar to the sequence discussed above. Thus, the data captures associated with the first capture rule are encrypted and sent in a manner that comports with the first target destination, and the data captures associated with the second data capture rule are encrypted and sent in a manner that comports with the second target destination.

Continuing the immediate example, some scenarios may result in data captures that are applicable to both the first and second example rules discussed above. For example, consider a scenario where both the first and second rules are applicable based on the first user subscriber communicating with the second user subscriber via the EPC 104. In this scenario, the capture arbitrator 378 may then generate separate encrypted data captures using respective key identifiers. Likewise, the capture arbitrator 378 can then send each encrypted data capture to a respective target destination.

However, in some instances subscriber agencies and/or subscriber users do not allow their associated communications to be sent to entities outside of their agency. Now consider that the aforementioned first subscriber user and/or second subscriber user belongs to an agency in this category. In the above example, the capture arbitrator 378 may be configured to encrypt the portions of a received data capture corresponding to the first user subscriber using an encryption key specific to the first subscriber user (or the subscriber agency of the first subscriber user), and likewise encrypt the portions of the received data capture corresponding to the second subscriber user using an encryption key specific to the second subscriber user (or the subscriber agency of the second subscriber user). The result may then be referred to as a secure multi-agency data capture, or a secure inter-agency data capture.

The capture arbitrator 378 can then send a capture notification message to the first and second URIs as discussed above to provide an indication of the data capture. The capture notification message in this example can provide a value that indicates that the data capture is a secure multi-agency (or inter-agency) data capture, and optionally the identifier of the subscriber agency and/or subscriber users associated with the data capture. This secure inter-agency data capture may also be referred to as an inter-agency data capture. The capture notification message may also provide an indication of which portions of the data capture correspond to the foreign agency. The capture notification message in this example may also further include an inter-agency capture identifier (e.g., a GUID) that uniquely identifies the inter-agency data capture within the mobile communication network 100, and/or a key identifier used for the encryption of the portion(s) of the data capture that were not associated with their particular agency/user. The receiving server, such as the logging recorder 280-1, may then use the inter-agency capture identifier to request the data capture (e.g., via a file share or USB driver transfer) from the owning entity for the second URI/destination, e.g., logging recorder 280-N, and thus obtain the portion that was encrypted in their respective copy of the communication.

Note, inter-agency data captures may also be sent to each agency's target destination(s) without necessarily encrypting/securing those portions of a data capture corresponding to the foreign agency with the foreign agency's keys. For instance, a data capture that is associated with two or more agency subscribers may be sent to respective target destination(s) in a manner that allows each respective subscriber agency to access the entirety of the communication, e.g., in plain text, with the entirety of the communication referring to both portion(s) associated with their agency and portion(s) associated with a foreign agency. The capture notification message sent by the capture arbitrator in this scenario may still provide the identifiers, as discussed above, to indicate that the data capture is an inter-agency data capture and/or to indicate which portions of the data capture correspond to each respective agency associated with the data capture.

In still another example scenario, an inter-agency data capture may be held in the local data store 384, for example, until a release condition is met. In this scenario, the capture arbitrator 378 may send a notification message to each target destination along with a flag/value indicating that the data capture is in a held state. The capture arbitrator 378 may then receive release authorization message(s) from one or more of the target destinations. The capture arbitrator 378 may then consider that the release condition has been met based on receiving a release authorization message from each of the target destinations. Alternatively, the capture arbitrator 378 may consider the release condition met if at least one release authorization message is received. The particular predetermined release condition for inter-agency data captures may be defined via the capture rules to comport with the particular requirements of each subscribing agency. In any event, the capture arbitrator 378 may then send a capture indication message to one or more of the target destinations to indicate that the inter-agency data capture has been transitioned from the ‘held’ state to the ‘released’ state and is available for retrieval. The capture arbitrator 378 may send this to all of the target endpoints, or alternatively, to only those target endpoints that a release authorization message was received from.

In another example scenario, the first logging recorder 280-1 or an entity that owns the first logging recorder can initiate a request to the capture arbitrator 378 that includes the identifier of the inter-agency capture identifier. The request can further include a copy of the inter-agency capture corresponding to the inter-agency capture identifier, or alternatively a URI or other location identifier for the capture arbitrator 378 to retrieve the inter-agency capture. Note, the inter-agency capture may already be available within the local data store 384 depending on a desired configuration. The capture arbitrator may then send a consent/authorization request message to the second logging recorder 280-1, or to a URI/location of a server associated with the agency owning the second logging recorder 280-N. The capture arbitrator 378 can receive a response (e.g., an ACK, or a release authorization message) from the second logging recorder 280-N, and based on the response, generate a data capture from the inter-agency capture that, in a general sense, “unlocks” those portions of the data capture that were unavailable because of the association with a different agency. This can include retrieving the necessary keys from the local key store and decrypting one or more portions of the inter-agency capture. This can also include re-encrypting the inter-agency capture using an encryption key within the local key store that is associated with the first logging recorder 280-1 and/or the agency owning the first logging recorder. The re-encrypted data capture may then be sent to the first logging recorder 280-1, or alternatively at least an identifier of the re-encrypted data capture may be sent to the first logging recorder 280-1.

In another example, the logging recorder 280-1 may be configured to receive data captures as variously disclosed herein. However, in this example the logging recorder 280-1 may not necessarily be owned by an agency and instead be owned by a non-agency entity such as a private business who offers archival logging features commercially to governmental and/or non-governmental agencies through, for example, cloud-based access or other System as a service (SaaS) architecture. The logging recorder 280-1 may be cloud-based, or an on-premises server. One or more agencies may authorize their respective data captures to be provided by the capture arbitrator 378 to the logging recorder 280-1. Therefore, the capture rules database 382 can include one or more rules that cause the data captures for the one or more agencies to be sent to the logging recorder 280-1 using methodologies as discussed above. An agency admin 399 or other persons authorized to retrieve records for their specific agency may then send request messages to the capture arbitrator 378 or to the logging recorder 280-1 to, for example, retrieve a list of data capture identifiers based on one or more query parameters (e.g., date/time, and/or subscriber identifier), and request data captures based on the returned list of data capture identifiers. The capture arbitrator 378 or the logging recorder 280-1 may then limit the results of such queries to only those data captures associated with the agency of the request agency admin 399. Further, each data capture stored within the logging recorder 280-1 is further preferably encrypted using encryption keys specific to the subscriber agency and/or subscriber user associated with a given data capture. Thus, in this example an inter-agency logging recorder can be achieved that permits shared storage for a plurality of agencies while ensuring that agency admins accessing that data are only able “see” the data captures associated with their particular agency.

In another example, the local data store 384 includes one or more data captures for an extended period of time. For instance, in certain scenarios network connectivity between the capture arbitrator 378 and target destinations, e.g., the logging recorders 280-1, 280-N may be down/disabled. In another example, data captures may not necessarily be sent via push notifications, and instead may be kept in the local data store 384 until the capture arbitrator receives a request message. In any such cases, the capture arbitrator 378 may utilize agency configuration data stored in an agency configuration database 391 to determine a retention period for the data captures held within the local data storage. The retention periods are generally set by each agency and/or by statutes and regulations that each agency operates under. Thus, the capture arbitrator 378 may be configured to delete those data captures within the local data store 384 which have exceeded their agency's maximum data retention period.

Accordingly, inter-agency data captures refer to data captures associated with two or more subscriber agencies. Secure inter-agency data captures refer to data captures where the portion(s) associated with a first subscriber user/agency are encrypted using different keys than the remaining portion(s) associated with other subscriber user/agencies. A secure inter-agency data capture, or at least an indication thereof, may then be sent to two or more different agencies (and more specifically, the target endpoints for those agencies) by the capture arbitrator 378. Each receiving subscriber agency may then be able to decrypt their respective portion(s) of the secure inter-agency data capture using their encryption keys while the remaining portion(s) of the secure inter-agency data capture associated with a foreign agency remain secured/inaccessible. Alternatively, or in addition, portions of a secure inter-agency data capture corresponding to a foreign agency may be redacted, e.g., removed, before sending to target endpoint(s). In this scenario, the capture arbitrator 378 can send a capture notification message that indicates the secure inter-agency data capture is in a redacted state, and optionally the particular parameters of the redacted portion such as the beginning and ending timestamps for the redaction, an identifier of the subscriber user/agency that was associated with the redacted portion, and an identifier of the capture rule(s) that caused the redaction, and/or a reason code or human-readable string/message that indicates the redaction occurred. The non-redacted portions of a secure inter-agency data capture, e.g., the portion(s) corresponding to a given subscriber agency rather than a foreign subscriber agency, are preferably accessible (e.g., decryptable) by the receiving subscriber agency.

Accordingly, each subscriber agency can potentially receive an identical copy of a secure inter-agency data capture with their portions being accessible (e.g., decryptable using their subscriber agency key(s)) and the portions corresponding to foreign agencies being secured by foreign agency keys. Alternatively, each subscriber agency could receive a redacted copy of an inter-agency data capture that redacts/removes the portion(s) associated with a foreign agency while maintaining/preserving the portion(s) associated with their agency.

In some cases, UICCs such as UICC 111 (See FIG. 1) can include a profile with a capture flag enabled. When this profile is activated by a UE, capture of communications associated with the UE may then be initiated by the MC capture controller 228 and output as data captures to the APC 250 as discussed above. However, in some scenarios the MC capture controller 228 may output data captures regardless of whether the capture flag is enabled for a UE. In this scenario, the APC 250 may then utilize the capture flag for providing recordings to a target destination, or not, as the case may be.

In any event, UICCs can include a profile with the aforementioned capture flag. The UICCs can also include a plurality of profiles with the capture flag set to enabled/true or false/disabled depending on a desired configuration. Consider an example where a subscriber user has a USIM that includes a first profile for a laptop computer and a second profile for a smart phone. The first profile can include the capture flag set to disabled, and the second profile can include the capture flag set to enabled. When the USIM is inserted into the laptop, the first profile is then activated and the capture flag is then set to false/disabled. Preferably, the subscriber user may then attach to the mobile communication network 100 and no data captures associated with the subscriber user are generated by the MC capture controller 228 and output to the APC 250 based on the first profile being activated. On the other hand, when the USIM is inserted into the smart phone, the second profile is then activated and the capture flag is set to true/enabled. In this scenario, the subscriber user may then attach to the mobile communication network 100, and the MC capture controller 228 then generates data captures associated with the MC capture controller 228 and outputs generated data captures to the APC 250 based on the second profile being activated.

Alternatively, or in addition, the capture flag for a given UE may be defined in the SU database 205 (see FIG. 2). The capture flag for a given UE may also be overridden by an agency capture flag within the SU database 205, for example.

Alternatively, or in addition, an “app” executed on a UE may be utilized to set the capture flag to true/enabled for a UE. In this example, the app may be authenticated with the mobile communication network 100, e.g., based on subscriber information stored in the SU 205. Based on this subscriber information stored within the SU 205, the subscriber can have the privilege level to initiate data capture for communications the subscriber is associated with (e.g., is a sender or receiver within the communication), and/or suspend/deactivate/pause/stop data captures. The app may also provide additional features including the ability to adjust an operating characteristic of the APC 250. Some such operating characteristics include the ability to modify/adjust capture rule(s) stored in the capture rules database 382. For instance, the app may be configured to retrieve, create, update, and/or delete a capture rule within the capture rules database 382 for their UE, or for a plurality of UEs based on the app (or agency admin) sending one or more provisioning messages.

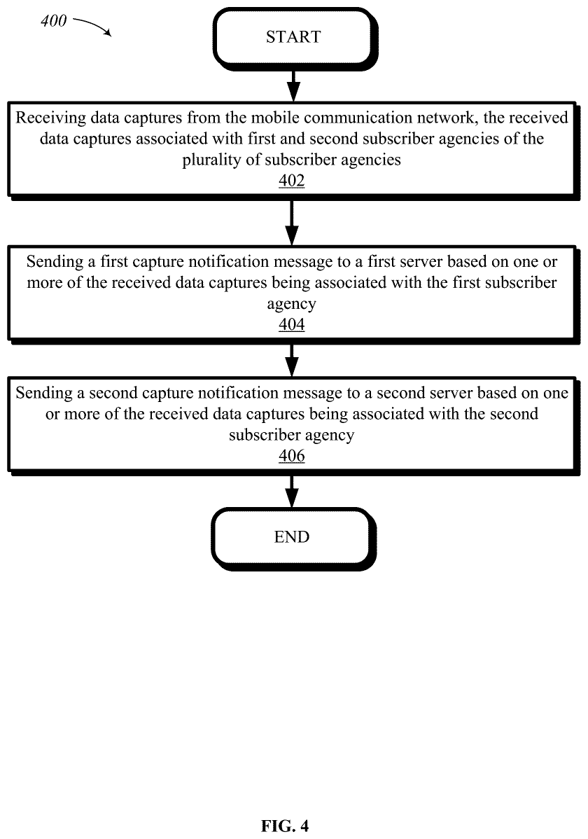

FIG. 4 shows an example method 400 that exemplifies various features and aspects of the foregoing. The method 400 can be executed by a controller, e.g., an APC controller, of a mobile communication network consistent with the present disclosure. The mobile communication network can include a plurality of subscriber agencies. The method 400 including receiving 402 data captures from the mobile communication network, the received data captures being associated with first and second subscriber agencies of the plurality of subscriber agencies. The method 400 further includes sending 404 a first capture notification message to a first server based on one or more of the received data captures being associated with the first subscriber agency, and sending 406 a second capture notification message to a second server based on one or more of the received data captures being associated with the second subscriber agency.

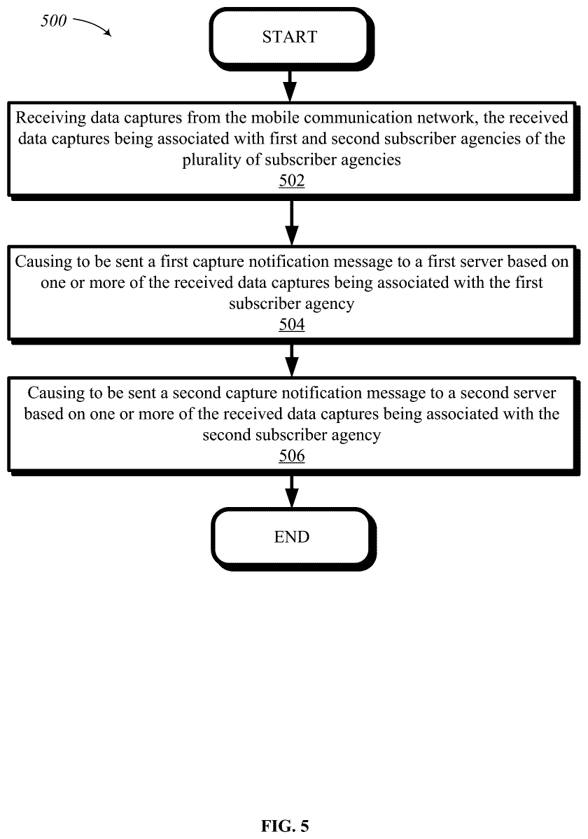

FIG. 5 shows an example method 500 that exemplifies various features and aspects of the foregoing. The method 500 can be executed by a controller, e.g., an APC controller, of a mobile communication network consistent with the present disclosure. The mobile communication network can include a plurality of subscriber agencies. The method 500 including receiving 502 data captures from the mobile communication network, the received data captures being associated with first and second subscriber agencies of the plurality of subscriber agencies. The method 500 further including causing 504 to be sent a first capture notification message to a first server based on one or more of the received data captures being associated with the first subscriber agency, and causing 506 to be sent a second capture notification message to a second server based on one or more of the received data captures being associated with the second subscriber agency.

Example 1 of the present disclosure is a system for arbitration of data captures from a mobile communications network, the system comprising a memory with a plurality of capture rules stored therein, each capture rule of the plurality of capture rules defining a criterion and being associated with a target destination, an archival plane controller (APC) to receive a first data capture from the mobile communications network, identify at least one capture rule of the plurality of capture rules stored in the memory that is associated with the first data capture, and send an indication of the first data capture to the target destination associated with the at least one identified capture rule.

Example 2 includes the features of Example 1, and wherein the target destination is an archival logging recorder.

Example 3 of the present disclosure is a system for arbitration of data captures from a mobile communications network, the system comprising a memory including a plurality of capture rules, each capture rule of the plurality of capture rules including a capture criterion, a target value or a range of target values associated with the capture criterion, an archival plane controller (APC) configured to receive a first data capture from the mobile communication network, the first data capture including a data payload and at least a first capture characteristic, identify at least a first capture rule of the plurality of capture rules based on the first capture characteristic of the first data capture having a corresponding value that is equal to the target value or within the range of target values for the capture criterion for the first capture rule, identify a target destination based on the first identified capture rule and cause an indication of the first data capture to be sent to the target destination.

Example 4 includes the features of Example 3, wherein the mobile communications network comprises an enhanced packet core (EPC) network that implements one or more nodes comporting with 3rd Generation Partnership Project (3GPP) standards.

Example 5 includes the features of Example 4, wherein the first data capture includes at least a portion of a communication propagated through the EPC network based on a communication initiated by a subscriber unit of the mobile communications network.

Example 6 includes the features of any one of Examples 3-5, wherein the first capture characteristic of the first data capture includes an identifier of an originating subscriber user of the mobile communications network and/or a receiving subscriber user of the mobile communications network.

Example 7 includes the features of Example 6, wherein the first capture rule is identified based on the target value for the first capture rule being equal to the identifier of the originating subscriber user and/or the identifier of the receiving subscriber user of the mobile communications network, or the range of target values for the first capture rule includes the identifier of the originating subscriber user and/or the identifier of the subscribing receiving user.

Example 8 includes the features of any one of Examples 3-7, wherein the first capture characteristic is an identifier of a subscriber agency of the mobile communications network, each subscriber agency of the mobile communications network having a plurality of subscriber users.

Example 9 includes the features of Example 8, wherein the first capture rule is identified based on the target value being equal to the identifier of the subscriber agency or the range of target values includes the identifier of the subscriber agency.

Example 10 includes the features of any one of Examples 3-9, wherein the mobile communication network comprises an enhanced packet core (EPC) network that implements one or more nodes comporting with 3rd Generation Partnership Project (3GPP) standards, a mission critical controller configured to provide a communication signaling plane for the EPC network, and a mission critical capture controller to generate data captures based on the mission critical controller, and wherein the APC is further configured to send a provisioning message to the mission critical capture controller, the provisioning message including an identifier of a subscriber user and/or an identifier of a subscriber agency and configured to cause mission critical capture controller to generate the data captures based on communications associated with the identifier of the subscribing user and/or the identifier of the subscriber agency occurring via the communication signaling plane of the mission critical controller.

Example 11 includes the features of Example 12, wherein the identifier of the subscribing user and/or the identifier of the subscriber agency is associated with a priority value, and wherein the mission critical capture controller is configured to send data captures to the APC in an order based on the priority value.

Example 12 includes the features of any one of Examples 3-11, wherein the first identified capture rule further includes an key identifier of a cryptographic key, and wherein the APC is further configured to cause encryption of the first received data capture based on the cryptographic key.

Example 13 includes the features of Example 12, wherein the APC is configured to receive the cryptographic key based on a request to an external keystore.

Example 14 includes the features of any one of Examples 3-13, wherein the first data capture comprises one or more image frames and/or audio samples.

Example 15 includes the features of any one of Examples 3-14, wherein the APC is configured to cause the indication of the first data capture, and at least a portion of the data payload to be sent to the target destination.

Example 16 includes the features of any one of Examples 3-15, wherein the indication sent to the target destination includes a unique identifier associated with the first data capture.

Example 17 includes the features of any one of Examples 3-16, wherein the target destination is associated with a universal resource locator (URI) or other identifier of an archival logging recorder.

Example 18 includes the features of any one of Examples 3-17, wherein the indication sent to the target destination includes an identifier of the first data capture, and wherein the APC is configured to receive, from a remote server via a network, a request for the first data capture that includes the identifier of the first data capture, and in response thereto, send at least a portion of the payload data of the first data capture to the remote server.

Example 19 includes the features of any one of Examples 3-18, wherein the APC is configured to receive an update message from a remote server, the update message causing a capture rule of the plurality of capture rules to be added, modified, or removed.

Example 20 includes the features of any one of Examples 3-19, wherein the APC is configured to send a provisioning message to a mission critical capture controller of the mobile communication network, the provisioning message to cause the mission critical capture controller to modify at least one operating configuration.

Example 21 of the present disclosure is a system for arbitration of data captures from a mobile communications network, the mobile communication network having a plurality of subscriber agencies, the system comprising an archival capture plane (APC) controller to receive data captures from the mobile communication network, the received data captures associated with first and second subscriber agencies of the plurality of subscriber agencies, and wherein the APC controller is configured to send a first capture notification message to a first server based on one or more of the received data captures being associated with the first subscriber agency, and send a second capture notification message to a second server based on one or more of the received data captures being associated with the second subscriber agency.

Example 22 includes the features of Example 21, wherein sending the first capture notification message to the first server further includes encrypting at least a portion of the one or more of the received data captures that are associated with the first subscriber agency using a first encryption key.

Example 23 includes the features of any Example 22, wherein sending the first capture notification message to the second server further includes encrypting at least a portion of the one or more of the received data captures that are associated with the second subscriber agency using a second encryption key, the first and second encryption keys being different.

Example 24 of the present disclosure is a method for arbitration of data captures from a mobile communications network, the mobile communication network having a plurality of subscriber agencies, the method comprising receiving, by an archival capture plane (APC) controller, data captures from the mobile communication network, the received data captures being associated with first and second subscriber agencies of the plurality of subscriber agencies, causing to be sent, by the APC controller, a first capture notification message to a first server based on one or more of the received data captures being associated with the first subscriber agency, and causing to be sent, by the APC controller, a second capture notification message to a second server based on one or more of the received data captures being associated with the second subscriber agency.

Example 25 includes the features of Example 24, wherein causing to be sent, by the APC controller, the first capture notification message further includes sending the first capture notification message to the first server via an evolved packet core (EPC) network provided by the mobile communication network.

Example 26 includes the features of Example 24, wherein causing to be sent, by the APC controller, the first capture notification message further includes sending the first capture notification message to the first server not via an evolved packet core (EPC) network provided by the mobile communication network.

Example 27 includes the features of Example 24, wherein one or more of the received data captures are inter-agency data captures, the inter-agency data captures being associated with the first subscriber agency and the second subscriber agency, and wherein the method further comprises causing to be sent, by the APC controller, a third capture notification message to the first server and a fourth capture notification message to the second server based on the inter-agency data captures.

While the principles of the disclosure have been described herein, it is to be understood by those skilled in the art that this description is made only by way of example and not as a limitation as to the scope of the disclosure. Other aspects and features are contemplated within the scope of the present disclosure in addition to the exemplary aspects and features shown and described herein. It will be appreciated by a person skilled in the art that a device, system, or method consistent with the present disclosure may embody any one or more of the features contained herein and that the features may be used in any particular combination or sub-combination. Modifications and substitutions by one of ordinary skill in the art are considered to be within the scope of the present disclosure, which is not to be limited except by the claims.

1. A system for arbitration of data captures from a mobile communications network, the system comprising:
a memory including a plurality of capture rules, each capture rule of the plurality of capture rules including a capture criterion, a target value or a range of target values associated with the capture criterion;
an archival plane controller (APC) configured to:
receive a first data capture from the mobile communication network, the first data capture including a data payload and at least a first capture characteristic;
identify at least a first capture rule of the plurality of capture rules based on the first capture characteristic of the first data capture having a corresponding value that is equal to the target value or within the range of target values for the capture criterion for the first capture rule;
identify a target destination based on the first identified capture rule; and
cause an indication of the first data capture to be sent to the target destination.

2. The system of claim 1, wherein the mobile communications network comprises an enhanced packet core (EPC) network that implements one or more nodes comporting with 3rd Generation Partnership Project (3GPP) standards.

3. The system of claim 2, wherein the first data capture includes at least a portion of a communication propagated through the EPC network based on a communication initiated by a subscriber unit of the mobile communications network.

4. The system of claim 1, wherein the first capture characteristic of the first data capture includes an identifier of an originating subscriber user of the mobile communications network and/or a receiving subscriber user of the mobile communications network.

5. The system of claim 4, wherein the first capture rule is identified based on the target value for the first capture rule being equal to the identifier of the originating subscriber user and/or the identifier of the receiving subscriber user of the mobile communications network, or the range of target values for the first capture rule includes the identifier of the originating subscriber user and/or the identifier of the subscribing receiving user.

6. The system of claim 4, wherein the first capture rule is identified based on the target value for the first capture rule being equal to the identifier of the originating subscriber user and/or the identifier of the receiving subscriber user of the mobile communications network, or the range of target values for the first capture rule includes the identifier of the originating subscriber user and/or the identifier of the subscribing receiving user.

7. The system of claim 1, wherein the first capture characteristic is an identifier of a subscriber agency of the mobile communications network, each subscriber agency of the mobile communications network having a plurality of subscriber users.

8. The system of claim 7, wherein the first capture rule is identified based on the target value being equal to the identifier of the subscriber agency or the range of target values includes the identifier of the subscriber agency.

9. The system of claim 1, wherein the mobile communication network comprises an enhanced packet core (EPC) network that implements one or more nodes comporting with 3rd Generation Partnership Project (3GPP) standards, a mission critical controller configured to provide a communication signaling plane for the EPC network, and a mission critical capture controller to generate data captures based on the mission critical controller, and wherein the APC is further configured to send a provisioning message to the mission critical capture controller, the provisioning message including an identifier of a subscriber user and/or an identifier of a subscriber agency and configured to cause mission critical capture controller to generate the data captures based on communications associated with the identifier of the subscribing user and/or the identifier of the subscriber agency occurring via the communication signaling plane of the mission critical controller.

10. The system of claim 9, wherein the identifier of the subscribing user and/or the identifier of the subscriber agency is associated with a priority value, and wherein the mission critical capture controller is configured to send data captures to the APC in an order based on the priority value.

11. The system of claim 1, wherein the first identified capture rule further includes a key identifier of a cryptographic key, and wherein the APC is further configured to cause encryption of the first received data capture based on the cryptographic key.

12. The system of claim 11, wherein the APC is configured to receive the cryptographic key based on a request to an external keystore.

13. The system of claim 1, wherein the first data capture comprises one or more image frames and/or audio samples.

14. The system of claim 1, wherein the APC is configured to cause the indication of the first data capture, and at least a portion of the data payload to be sent to the target destination.

15. The system of claim 1, wherein the indication sent to the target destination includes a unique identifier associated with the first data capture.

16. The system of claim 1, wherein the target destination is associated with a universal resource locator (URI) or other identifier of an archival logging recorder.

17. The system of claim 1, wherein the indication sent to the target destination includes an identifier of the first data capture, and wherein the APC is configured to receive, from a remote server via a network, a request for the first data capture that includes the identifier of the first data capture, and in response thereto, send at least a portion of the data payload of the first data capture to the remote server.

18-19. (canceled)

20. A system for arbitration of data captures from a mobile communications network, the mobile communication network having a plurality of subscriber agencies, the system comprising:
an archival capture plane (APC) controller to receive data captures from the mobile communication network, the received data captures associated with first and second subscriber agencies of the plurality of subscriber agencies; and
wherein the APC controller is configured to send a first capture notification message to a first server based on one or more of the received data captures being associated with the first subscriber agency, and send a second capture notification message to a second server based on one or more of the received data captures being associated with the second subscriber agency.

21. The system of claim 20, wherein sending the first capture notification message to the first server further includes encrypting at least a portion of the one or more of the received data captures that are associated with the first subscriber agency using a first encryption key.

22. The system of claim 21, wherein sending the first capture notification message to the second server further includes encrypting at least a portion of the one or more of the received data captures that are associated with the second subscriber agency using a second encryption key, the first and second encryption keys being different.

23-26. (canceled)
